(19) United States
(12) Patent Application Publication
(10) Pub. No.: US 2016/0179379 A1
(43) Pub. Date: Jun. 23, 2016

(54) SYSTEM AND METHOD FOR DATA MANAGEMENT ACROSS VOLATILE AND NON-VOLATILE STORAGE TECHNOLOGIES

(71) Applicant: Teradata US, Inc., Dayton, OH (US)

(72) Inventors: Daniel D. Hoffman, San Diego, CA (US); William T. Sanders, San Diego, CA (US); Supen B. Shah, San Diego, CA (US); David E. Steinke, San Diego, CA (US)

(73) Assignee: Teradata US, Inc., Dayton, OH (US)

(21) Appl. No.: 14/977,699

(22) Filed: Dec. 22, 2015

Related U.S. Application Data
(60) Provisional application No. 62/096,064, filed on Dec. 23, 2014.

(51) Int. Cl. G06F 3/06; G06F 12/06

(52) U.S. Cl. CPC G06F 3/061; G06F 3/0688; G06F 3/0655; G06F 12/0638; G06F 2212/205

(57) ABSTRACT

A system and method for allocating different temperature data to storage devices within a computer system including inexpensive non-volatile storage, such as hard disk drive (HDD) storage devices; expensive non-volatile storage, such as solid-state drive (SSD) storage devices; and expensive volatile storage, such as system cache memory. The system and method allocates cold to warm data having access frequencies up to a first access frequency threshold to inexpensive non-volatile storage; allocates hot data having access frequencies greater than the first access frequency value and ranging up to a second access frequency threshold, to expensive non-volatile storage; and allocates very hot data having access frequencies greater than the second access frequency value and which resides during normal system operation in expensive volatile storage, to said inexpensive non-volatile storage.

### CROSS REFERENCE TO RELATED APPLICATIONS

This application claims priority under 35 U.S.C. §119(e) to the following co-pending and commonly-assigned patent application, which is incorporated herein by reference:

Provisional Patent Application Ser. No. 62/096,064, entitled “IMPROVED SYSTEM AND METHOD FOR DATA MANAGEMENT ACROSS VOLATILE AND NONVOLATILE STORAGE TECHNOLOGIES,” filed on Dec. 30, 2014, by Daniel Hoffman, Bill Sanders, Supen Shah, and Dave Steinke.

### FIELD OF THE INVENTION

The present invention relates to data warehouse systems, and more particularly, to an improved system and method for allocating resources in a mixed SSD and HDD storage environment

### BACKGROUND OF THE INVENTION

Solid state storage, in particular, flash-based devices either in solid state drives (SSDs) or on flash cards, is quickly emerging as a credible tool for use in enterprise storage solutions. Ongoing technology developments have vastly improved performance and provided for advances in enterprise-class solid state reliability and endurance. As a result, solid state storage, specifically flash storage deployed in SSDs, is becoming vital for delivering increased performance to servers and storage systems, such as the data warehouse system illustrated in FIG. 1.

The system illustrated in FIG. 1, a product of Teradata Corporation, is a hybrid data warehousing platform that provides the capacity and cost benefits of hard disk drives (HDDs) while leveraging the performance advantage of solid-state drives (SSDs). As shown the system includes multiple physical processing nodes 101, connected together through a communication network 105. Each processing node may host one or more physical or virtual processing modules, such as one or more access module processors (AMPs). Each of the processing nodes 101 manages a portion of a database that is stored in a corresponding data storage facility including SSDs 120, providing fast storage and retrieval of high demand “hot” data; and HDDs 110, providing economical storage of lesser used “cold” data.

Teradata Virtual Storage (TVS) software 130 manages the different storage devices within the data warehouse, automatically migrating data to the appropriate device to match its temperature. TVS replaces traditional fixed assignment disk storage with a virtual connection of storage to data warehouse work units, referred to as AMPs, within the Teradata data warehouse, FIG. 2 provides an illustration of allocation of data storage in a traditional Teradata Corporation data warehouse system, wherein each AMP within a processing node 101 owns the same number of specific disk drives 125 and places its data on those drives without consideration of data characteristics or usage.

FIG. 3 provides an illustration of allocation of data storage in a Teradata Corporation data warehouse system utilizing Teradata Virtual Storage (TVS). Storage is owned by Teradata Virtual Storage and is allocated to AMPs in small pieces from a shared pool of disks 125. Data are automatically and transparently migrated within storage based on data temperature. Frequently used hot data is automatically migrated to the fastest storage resource. Cold data, on the other hand, is migrated to slower storage resources.

Teradata Virtual Storage allows a mixture of different storage mechanisms and capacities to be configured in an active data warehouse system, TVS blends the performance-oriented storage of small capacity drives with the low cost-per-unit of large capacity storage drives so that the data warehouse can transparently manage the workload profiles of data on the storage resources based on application of system resources to the usage.

Systems for managing the different storage devices within the data warehouse, such as TVS, are described in U.S. Pat. No. 7,562,195; and United States Patent Application Publication Number 2010-0306493, which are incorporated by reference herein.

Described below is an improved system and method for allocating resources in a mixed SSD and HDD storage environment.

### BRIEF DESCRIPTION OF THE DRAWINGS

FIG. 1 is an illustration of a multiple-node database system employing SSD storage devices and conventional disk storage devices.

FIG. 2 is a simple illustration of the allocation of data storage in a traditional Teradata Corporation data warehouse system.

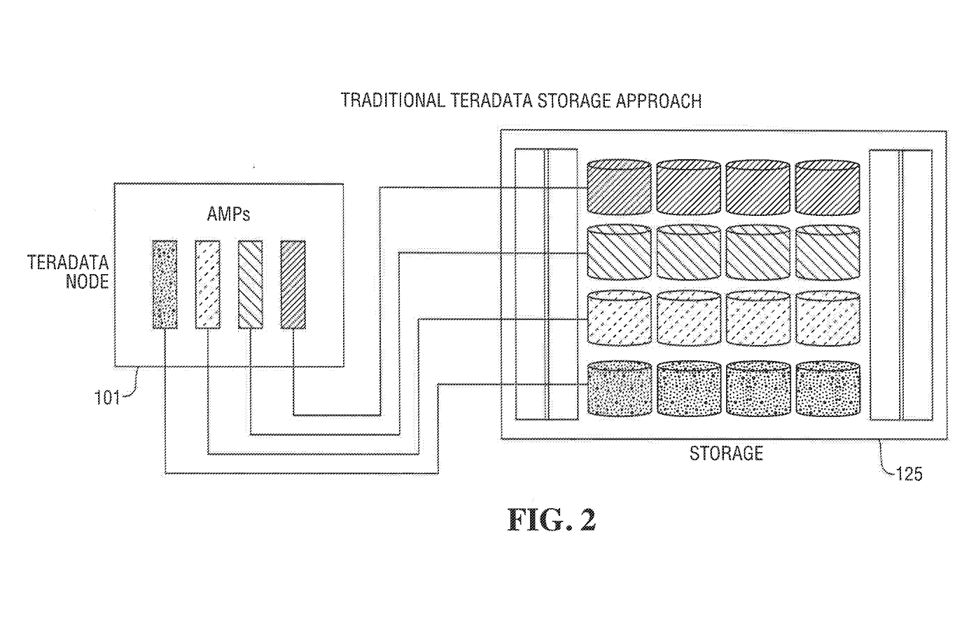

FIG. 3 is a simple illustration of the allocation of data storage in a Teradata Corporation data warehouse system utilizing Teradata Virtual Storage (TVS).

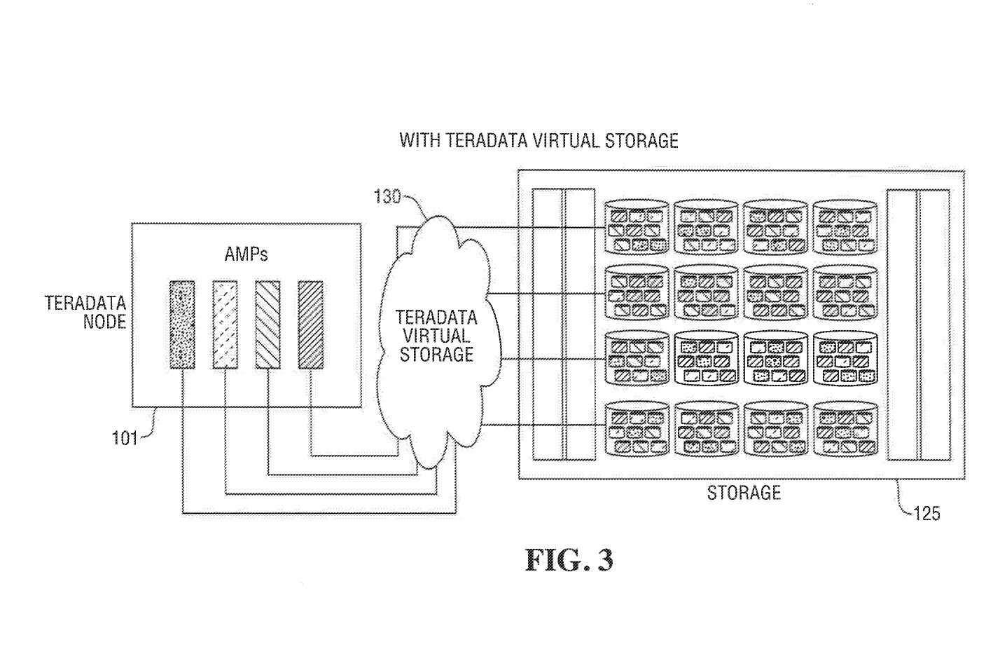

FIG. 4 illustrates the relative differences in data access times for SSD storage devices, conventional disk storage devices, and other components of a computer system.

FIG. 5 is a graph illustrating the relative differences in performance for SSD storage devices and conventional disk storage devices.

FIG. 6 is a graph illustrating the relative differences in cost per storage capacity for SSD storage devices and conventional disk storage devices.

FIG. 7 is a graph illustrating a current methodology for allocating data within a computer system to conventional disk storage devices, SSD storage devices, and system cache memory.

FIG. 8 is a graph illustrating an improved methodology for allocating data within a computer system to conventional disk storage devices, SSD storage devices, and system cache memory in accordance with the present invention.

FIG. 9 further illustrates the improved methodology for allocating data within a computer system to conventional disk storage devices, SSD storage devices, and system cache memory.

FIG. 10 is a graph illustrating an alternative methodology for allocating data within a computer system to conventional disk storage devices, SSD storage devices, and system cache memory in accordance with the present invention.

### DETAILED DESCRIPTION OF THE INVENTION

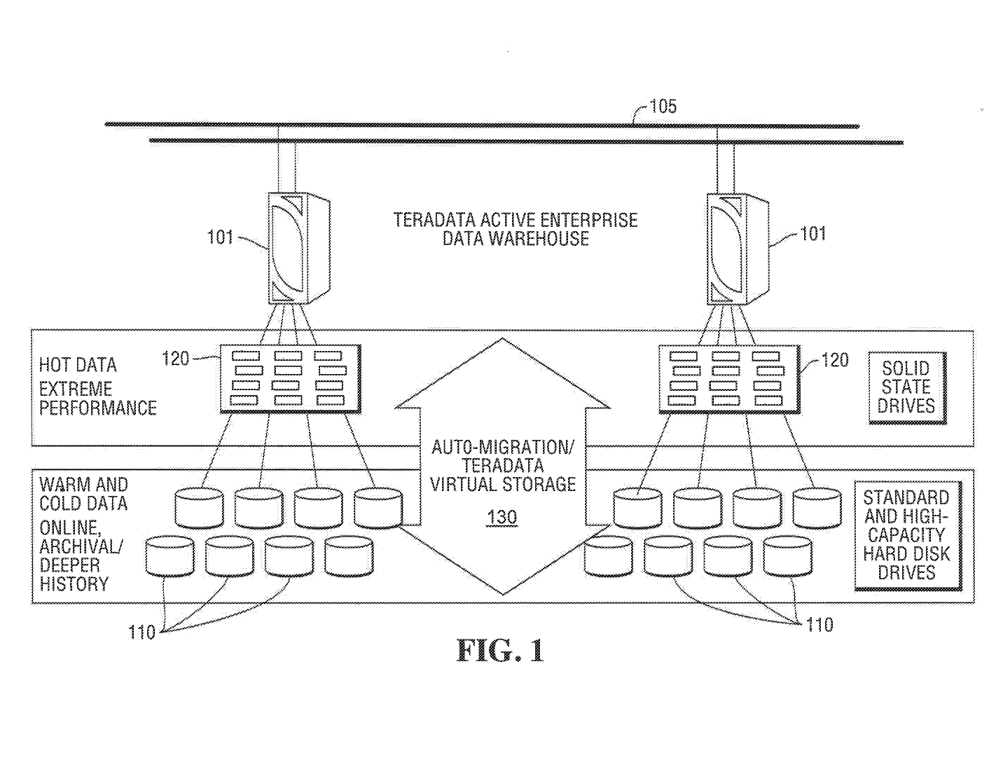

Hybrid database systems, such as the system illustrated in FIG. 1, store and manage data in storage facilities including SSDs, providing fast storage and retrieval of high demand “hot” data, and HDDs, providing economical storage of lesser used “cold” data. In addition, data in use by the system resides, at least temporarily, within volatile memory, such as system cache memory.

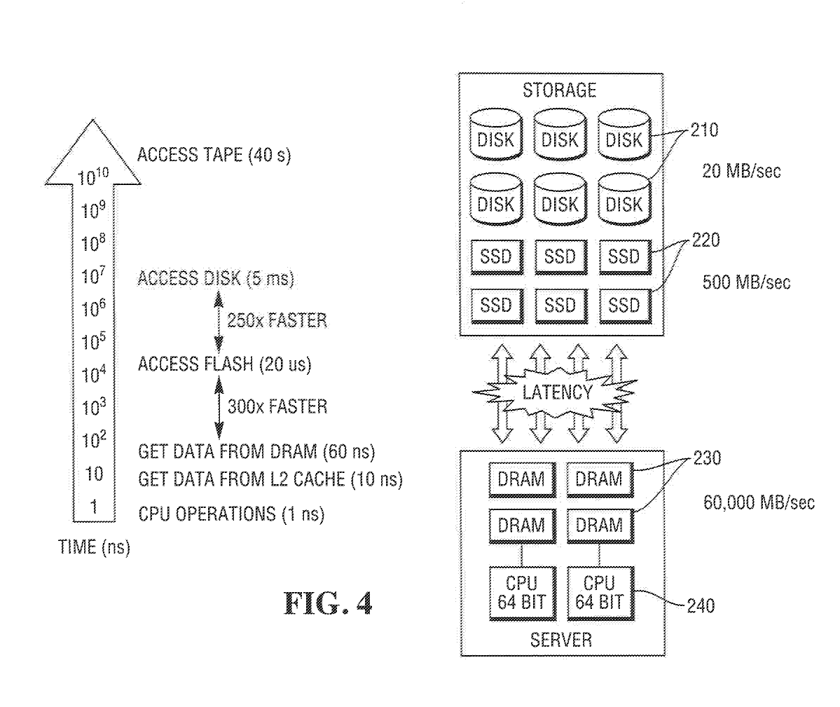

FIG. 4 provides a comparison of data access times and data transfer rates for conventional HDD storage devices 210, SSD storage devices 220, DRAM memory 230, and CPU cache memory 240. As illustrated in FIG. 4, access to data in SSD storage 220 and data transfer rates for SSD storage are much faster than for HDD storage 210, and access to data in system cache memory 230 and data transfer rates for system cache memory are much faster than for SSD storage 220 and HDD storage 210.

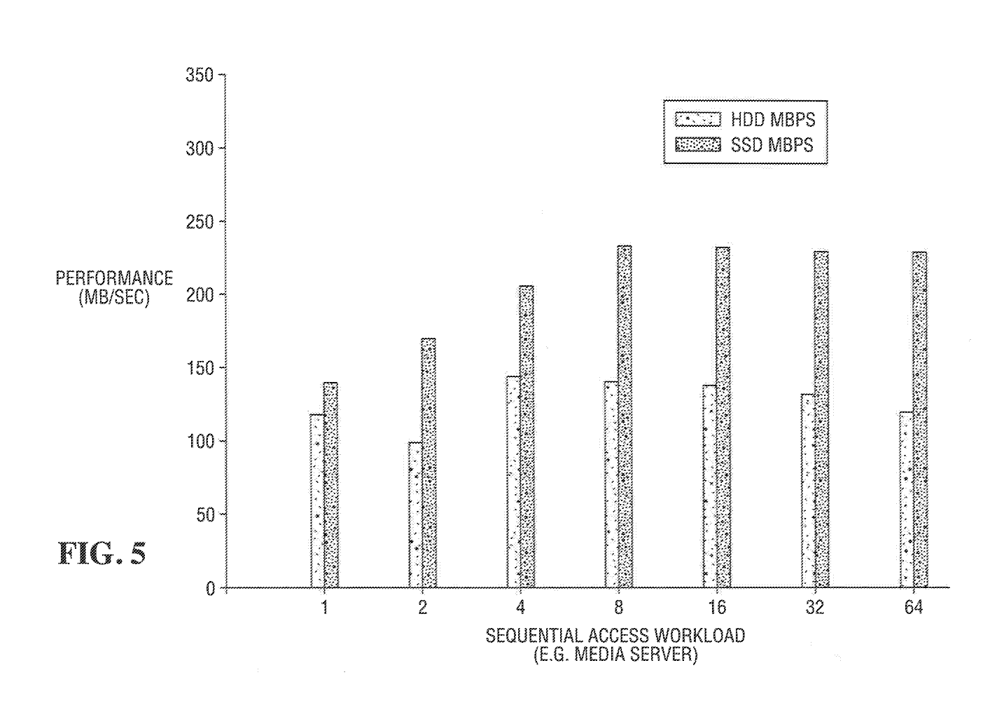

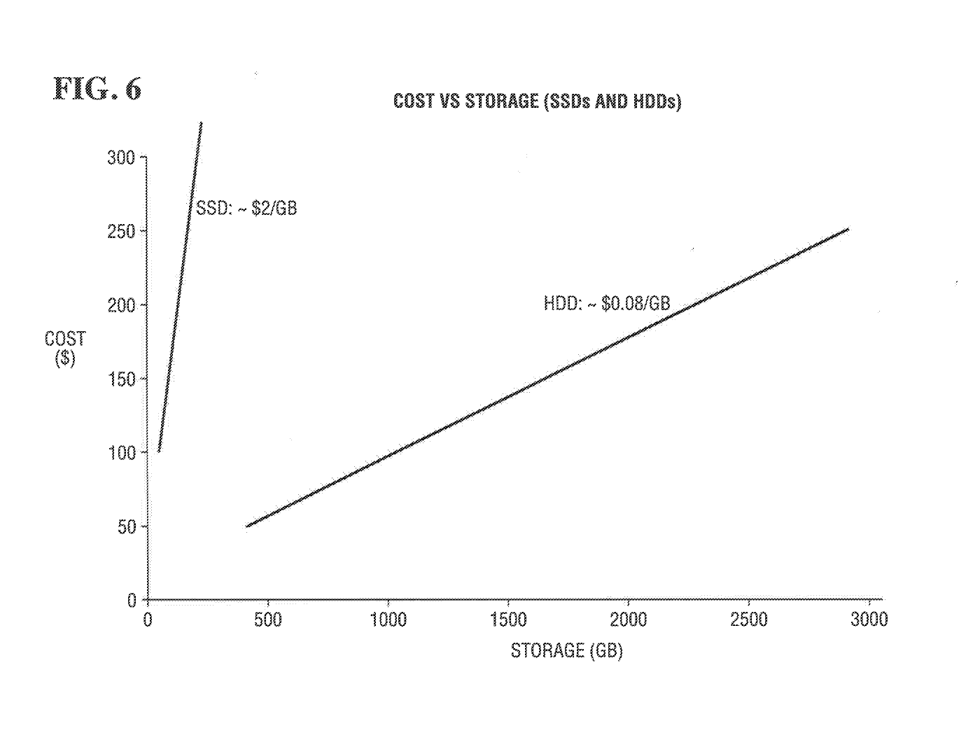

The graphs of FIGS. 5 and 6 further illustrate the differences in contemporary performance and costs for SSD storage devices and conventional disk storage devices. FIG. 5 shows the relative differences in performance for SSD storage devices and HDD storage devices, and FIG. 6 illustrates the relative differences in cost per storage capacity for SSD storage devices and HDD storage devices.

In more recent computer systems, the proportion of volatile memory, i.e., cache memory, to non-volatile memory in the system has increased. The non-volatile memory ranges from fast and expensive storage memory, such as SSD storage devices, to slow and inexpensive memory, such as HDD storage devices. Due to this increase in use of volatile memory, a larger percentage of the most frequently accessed data resides both in expensive nonvolatile memory and expensive volatile memory. As a result, the performance benefit of utilizing expensive nonvolatile memory for the storage of hot data, which also resides in expensive volatile memory, is lost.

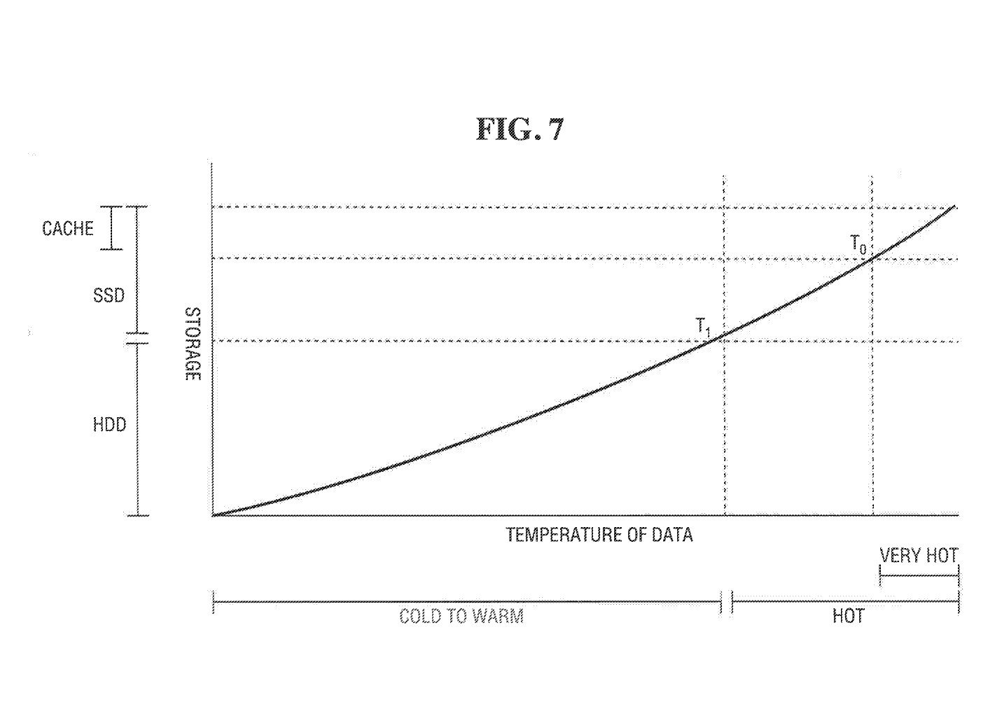

The graph provided in FIG. 7 illustrates a current methodology for allocating data within a computer system to conventional disk storage devices, SSD storage devices, and system cache memory. FIG. 7 shows memory storage type, e.g., HDD storage, SSD storage, and system cache memory along the vertical axis with faster and more expensive storage located above slower less expensive storage. Data temperature, or access frequencies, are shown along the horizontal axis. Cold to warm data, i.e., data with lower access frequency, is allocated to HDD storage, as shown by the line graph left of data access frequency threshold T1. Hot data, i.e., data, with higher access frequency, is allocated to SSD storage, as shown by the line graph right of T1. Very hot data, in addition to being allocated to SSD storage, is also maintained consistently in system cache memory due to its much higher access frequency, as shown by the line graph right of data access frequency threshold T0.

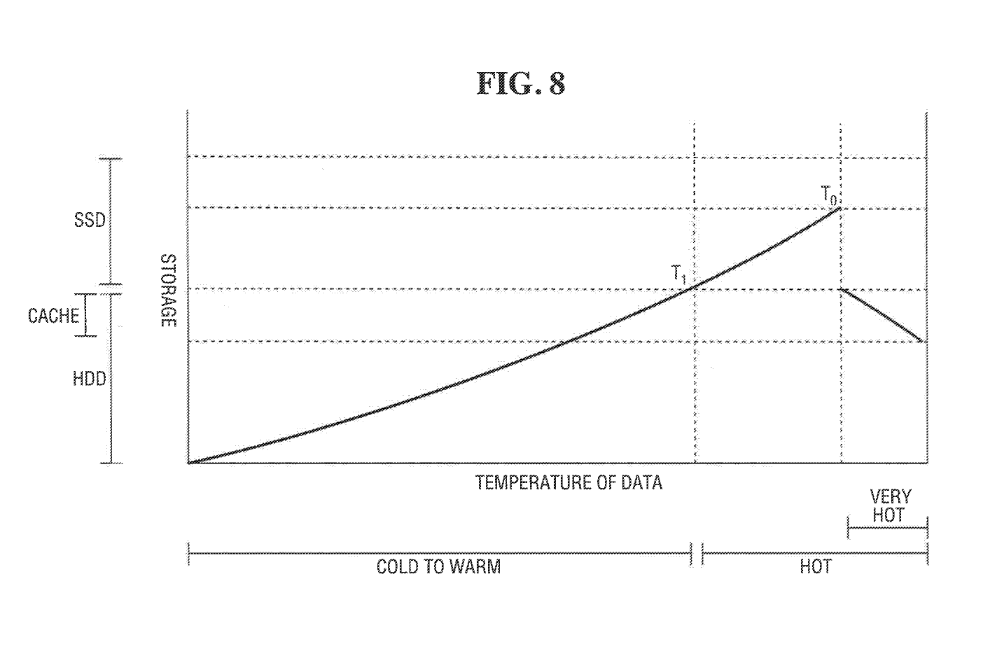

An improved methodology for allocating data within a computer system to conventional disk storage devices, SSD storage devices, and system cache memory is illustrated in the graph of FIG. 8. System performance is increased by ensuring that very hot data always contained in volatile memory is not also occupying space on expensive nonvolatile memory, which can otherwise be used for storing warm data that is not in volatile memory. Referring to FIG. 8, hot data, i.e., data between data access thresholds T1 and T0, is allocated to SSD storage devices. Very hot data, i.e., data with temperatures above T0 and which is always in volatile memory, is allocated to HDD storage rather than SSD storage. The allocation of very hot data to HDD storage, releases SSD storage for storage of additional hot data.

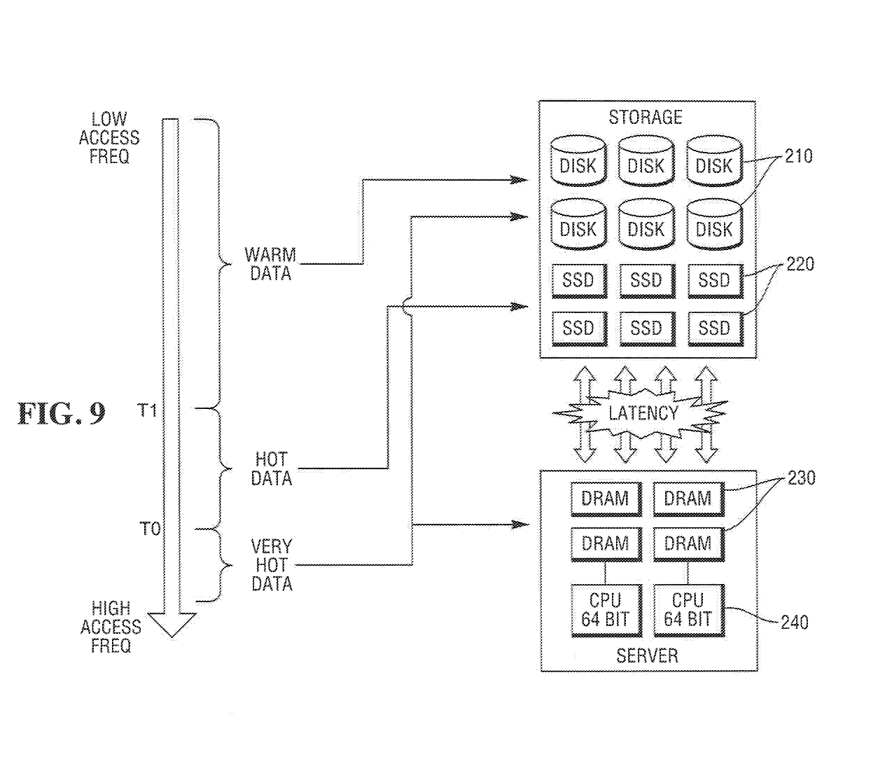

FIG. 9 provides an additional illustration of the improved methodology for allocating data within a computer system to conventional disk storage devices, SSD storage devices, and system cache memory discussed above. Referring to FIG. 9, hot data, i.e., data between T1 and T0, is allocated to SSD storage devices 220. Very hot data, i.e., data with temperature greater than T0 and which is always in volatile memory, is allocated to HDD storage 210 rather than SSD storage.

The amounts of expensive nonvolatile, cheap nonvolatile, and expensive volatile are all set per system and available programmatically. From these the value of T0 at the border of the expensive volatile memory and expensive nonvolatile memory, and the value of T1 at the border of the expensive nonvolatile memory and cheap nonvolatile memory, shown in FIG. 8, can be determined.

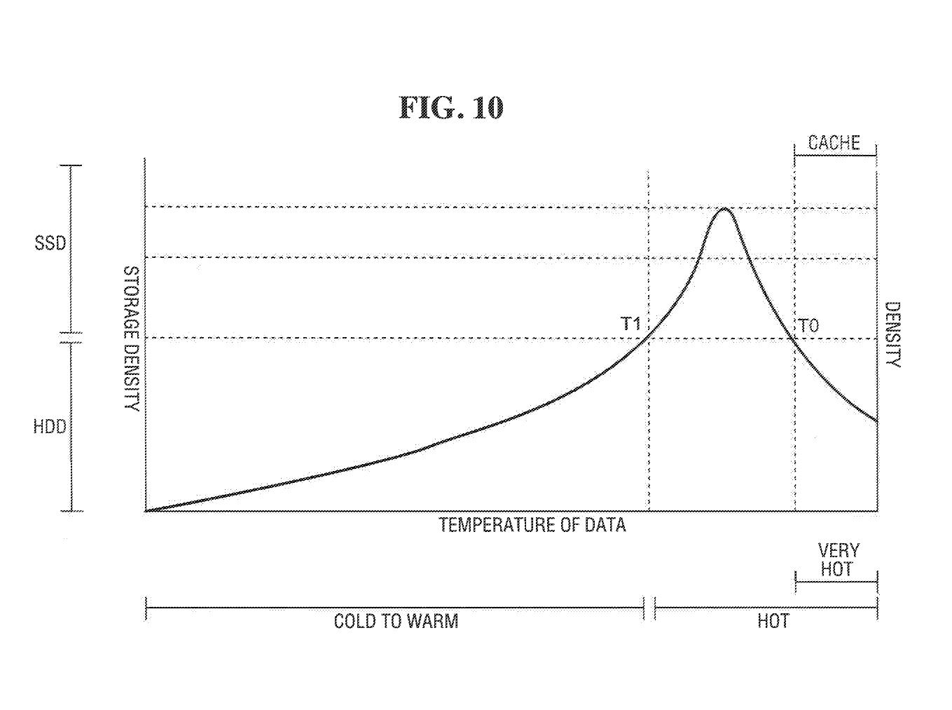

FIG. 10 illustrates an alternative methodology for allocating data within a computer system to conventional disk storage devices, SSD storage devices, and system cache memory. Whereas the methodology illustrated by the graph of FIG. 8 shows a discontinuity at T0, the methodology illustrated by the graph of FIG. 10 provides a smooth transition from expensive nonvolatile SSD memory, to cheap nonvolatile HDD storage for data residing in expensive volatile storage.

The methodology illustrated by the graph of FIG. 10 utilizes a density value along with data temperature to allocate data to expensive nonvolatile SSD memory or less expensive nonvolatile HDD storage. Temperature and density values are defined as follows:

```
 T0 - temperature at the border between expensive volatile and
expensive nonvolatile;
 T1 - temperature at the border between expensive nonvolatile and cheap
nonvolatile;
 If temperature < T0
      density = temperature
      decayDensityFlag = off
 If temperature >= T0
      If decayDensityFlag==on
            density = decay (density)
      Else
            density = T1
            decayDensityFlag = on
```

where decay is the same function that decay's temperature over time when data is not accessed.

Using the methodology illustrated in FIG. 10, temperature as the frequency of access is still maintained throughout TVS, subject to the decay algorithms in place used within TVS, and temperature remains the determining factor of what data is sent to cache memory. However, temperature is no longer the determining factor in where to place data on nonvolatile storage. Density replaces temperature in TVS and is used to determine whether or not data is stored on expensive nonvolatile or cheap nonvolatile storage.

The figures and specification illustrate and describe a new method for allocating resources in a mixed SSD and HDD storage environment which extends the use of expensive nonvolatile storage for frequently accessed data, and maximizes realization of customer investment in expensive nonvolatile hardware.

In the figures and discussion above, reference is made to SSD storage devices, HDD storage devices, and system cache storage technologies, but the invention is not limited to these specific storage technologies. Consideration should be given to a spectrum storage technologies by price and performance from the most fast-expensive volatile storage to slow-cheap nonvolatile storage. System performance can be increased by ensuring that data always in volatile storage is not wasting space on expensive nonvolatile storage that could otherwise be used for data that is never in volatile storage.

The foregoing description of the invention has been presented for purposes of illustration and description. It is not intended to be exhaustive or to limit the invention to the precise form disclosed. Additional alternatives, modifications, and variations will be apparent to those skilled in the art in light of the above teaching.

What is claimed is:

1. A computer system comprising:
a data storage system including:
inexpensive non-volatile storage;
expensive non-volatile storage; and
expensive volatile storage; and
a processor for:
allocating data having access frequencies up to a first access frequency threshold to said inexpensive non-volatile storage;
allocating data having access frequencies greater than said first access frequency value and ranging up to a second access frequency threshold, to said expensive non-volatile storage; and
allocating data having access frequencies greater than said second access frequency value and which resides in said expensive volatile storage, to said inexpensive non-volatile storage,

2. The computer system in accordance with claim 1, wherein:
said inexpensive non-volatile storage comprises hard disk drive (HDD) storage devices;
said expensive non-volatile storage comprises solid-state drive (SSD) storage devices; and
said expensive volatile storage comprises system cache memory.

3. In a computer system including a data storage system, said data storage system including inexpensive non-volatile storage, expensive non-volatile storage; and expensive volatile storage, a method for allocating data to said storage system, the method comprising the steps of:
allocating data having access frequencies up to a first access frequency threshold to said inexpensive non-volatile storage;
allocating data having access frequencies greater than said first access frequency value and ranging up to a second access frequency threshold, to said expensive non-volatile storage; and
allocating data having access frequencies greater than said second access frequency value and which resides in said expensive volatile storage, to said inexpensive non-volatile storage.

4. The Method for allocating data to a storage system within a computer system in accordance with claim 3, wherein:
said inexpensive non-volatile storage comprises hard disk drive (HDD) storage devices;
said expensive non-volatile storage comprises solid-state drive (SSD) storage devices; and
said expensive volatile storage comprises system cache memory.

5. A data storage system, comprising:
inexpensive non-volatile storage;
expensive non-volatile storage; and
expensive volatile storage; and
wherein:
data having access frequencies up to a first access frequency threshold are allocated to said inexpensive nonvolatile storage;
data having access frequencies greater than said first access frequency value and ranging up to a second access frequency threshold, are allocated to said expensive non-volatile storage; and
data having access frequencies greater than said second access frequency value and which resides in said expensive volatile storage, are allocated to said inexpensive non-volatile storage.

6. The data storage system in accordance with claim 3, wherein:
said inexpensive non-volatile storage comprises hard disk drive (HDD) storage devices;
said expensive non-volatile storage comprises solid-state drive (SSD) storage devices; and
said expensive volatile storage comprises system cache memory.

7. A computer system comprising:
a data storage system for storage of multiple temperature data; said data storage system comprising:
inexpensive non-volatile storage;
expensive non-volatile storage; and
expensive volatile storage; and
a processor for:
allocating cold to warm data to said inexpensive non-volatile storage;
allocating hot data to said expensive non-volatile storage; and
allocating very hot data to said expensive volatile storage.

8. The computer system in accordance with claim 7, wherein:
said cold to warm data comprises data having access frequencies up to a first access frequency threshold;
said hot data comprises data having access frequencies greater than said first access frequency value and ranging up to a second access frequency threshold; and
said very hot data comprises data having access frequencies greater than said second access frequency value

9. The computer system in accordance with claim 7, wherein:
said inexpensive non-volatile storage comprises hard disk drive (HDD) storage devices;
said expensive non-volatile storage comprises solid-state drive (SSD) storage devices; and
said expensive volatile storage comprises system cache memory.
